(19) United States
(12) Patent Application Publication
(10) Pub. No.: US 2006/0010293 A1
(43) Pub. Date: Jan. 12, 2006

(54) Cache for file system used in storage system

(76) Inventors: Michael Gordon Schnapp, Banqiao City (TW); Shiann-Wen Sue, Banqiao City (TW)

Correspondence Address: DENNISON, SCHULTZ, DOUGHERTY & MACDONALD;David E. Dougherty, Suite 105, 1727 King Street, Alexandria, VA, 22314, US

(21) Appl. No.: 11/174,647

(22) Filed: Jul. 6, 2005

Related U.S. Application Data
(60) Provisional application No. 60/521,838, filed on Jul. 9, 2004.

(51) Int. Cl. G06F 12/00

(52) U.S. Cl. 711/119

(57) ABSTRACT

A storage system and the cache device of the file system thereof are provided by the present invention. Each file system comprises at least one disk cache composed of a data cache unit used to temporarily store regular data and a plurality of dedicated cache units used to temporarily store special data, in order to avoid the loss of the special data owing to accessing the regular data when the storage system frequently accesses the data in the file system or accesses larger files thereof. The cache units mentioned above support a write-back caching function. When the host accesses the file data in a disk drive, the modified regular data and the metadata are stored in the corresponding cache units, and then the modified data is written into the disk drive by means of the cache units.

### BACKGROUND OF THE INVENTION

1. Field of the Invention

The present invention is related to a caching device, and more particularly related to the caching device for file systems used in storage systems.

2. Related Art

As a device for speeding accesses of memories or disks, a cache can copy the data from lower-speed storage devices (ex. disks) to higher-speed storage devices (ex. memories) to perform writing or reading commands so as to speed up the responses of systems.

The caching operation is basically deployed by using higher-speed storage devices in which retains a copy of data copied from lower-speed storage devices to allow readings or writings performed first on the higher-speed storage devices when it is required to read or write data from the lower-speed storage devices, and thus to speed up the responses of systems.

For example, a random access memory (RAM), which constitutes the main memory of a computer system, is running much faster than a disk so that the RAM memory can be partly used to be a cache of the disk. While reading the data of the disk, a copy of the read data will be stored in the cache. If the system repeats requests to read or write the same data or sectors which are already stored on the cache, the system can directly execute reading or writing actions on the cache memory instead. This method can improve the accessing speed of the system.

Regarding a storage system, a cache is also able to be used to its file systems to improve the overall performance of the system. The relationship between a storage system and a file system will be described in advance. A storage system can contain multiple physical storage devices, such as hard disk drives. The multiple physical storage devices can constitute one or more logical drives, and each logical drive can be further partitioned into multiple partitioned logical drives. Every logical drive has one file system in case of no further partition happened thereon. Oppositely, when the logical drive is partitioned into multiple partitioned ones, every partitioned logical drives also has its own file system. Therefore, a single storage system may include one or more file systems.

FIG. 1 is a schematic drawing showing a disk cache 1 in a commonly-seen file system, in which the disk cache 1, existing in a faster storage device like a memory, is divided into an Index Node Cache (Inode Cache) 11 and a Data Cache 12. The Inode Cache 11 is used to temporarily store Inode, which is a single storing section in the size of, for example, 128 bytes, and is used to store metadata for describing the permission attribute, the file size, and the location of data block of a file. An exclusive Inode will link to a file by the file system when the file is initially created. Thus, the file system can access the file by means of the Inode. The Inode and the data of the file system are stored in storage devices, such as disk drives. Data Cache 12 is used to temporarily store file data, allocation group headers, free space map list headers and super blocks etc. of a file system, which are metadata other than the Inode's and the relative data of a file system.

However, the cache arrangement in FIG. 1 has some drawbacks. When the file system bears heavy loadings or the data accessed from the file system is huge, the content of the disk cache 1 will be frequently renewed and it will result in a low system performance. Due to the limited space of the Data Cache 12, for example, 512 MB, the most data, even the whole thereon will be renewed while accessing a huge file, for example, 10 GB. While renewal happened, the situation described above is likely to lose allocation group headers (AG Headers), super blocks and/or free space list headers etc. that are other metadata relative to the file system and temporally stored on Data Cache 12 previously. When accessing the file system again, the free space list header, having been read earlier for indexing the free space data blocks, could be lost owing to the Data Cache 12 renewal. Consequently, the storage system has to read the free space list header from low-speed storage devices, like disk drives, again so that the accessing performance of the system will decline. To be concluded, it is hard to improve the performance of a system because the techniques in prior art usually store a part of frequently-used special data (a part of metadata) on the Data Cache 12 and this arrangement often cause the frequently-used special data to be lost.

For the forging reasons, it is a significant issue to design a new cache arrangement applied for file systems without the negative influence on the performance thereof.

### SUMMARY OF THE INVENTION

The main object of the present invention is to provide a cache device for a storage system and its file system to improve the accessing performance of the systems.

The cache device provided according to a feature of the present invention is used in a file system, and the cache device comprises a data cache unit used to temporarily store regular data, and a plurality of dedicated cache units that are used to store various types of special data whereby an influence of the renewing of the data cache unit on the special data in the dedicated cache units is reduced.

The cache device provided according to another feature of the present invention is used in a file system, and the cache device comprises a first cache unit used to temporarily store the regular data, a second cache unit used to temporarily store first special data, and a third cache unit used to temporarily store second special data whereby an influence of the renewing of the first cache unit on the special data is reduced. Wherein the first cache unit has a size larger than the sum of the second cache unit and the third cache unit.

The storage system provided according to a further feature of the present invention comprises a plurality of storage devices, in which each has at least one file system using a data cache unit to temporarily store regular data, and a plurality of dedicated cache units, which are used to respectively temporarily store a plurality of special data, whereby an influence of the renewing of the data cache unit on the special data in the dedicated cache units is reduced.

The storage system provided according to a further feature of the present invention comprises a plurality of storage devices, in which each has at least one file system using a first cache unit to temporarily store regular data, a second cache unit, which is used to temporarily store first special data, and a third cache unit, which is used to temporarily store second special data, whereby an influence of the renewing of the first cache unit on the special data is reduced. Wherein the first cache unit has a size larger than the sum of the second cache unit and the third cache unit.

The storage system provided according to a further feature of the present invention comprises at least one low-speed storage device, at least one high-speed storage device and a host. Wherein, the low-speed storage device stores a plurality of file data and each the file data has regular data and a variety of metadata; the high-speed storage device has a data cache unit used to temporarily store regular data, and a plurality of dedicated cache units corresponding to different metadata, are respectively used to temporarily store the metadata; and, the host is used to execute the storing operations of the storage devices. When the host reads a file data from the low-speed storage device, the regular data of the file data will be stored in the data cache unit and the metadata will be temporarily stored in the corresponding dedicated cache units.

The storage system provided according to a further feature of the present invention comprises at least one low-speed storage device, at least one high-speed storage device and a host. Wherein, the low-speed storage device has at least one file system and stores a plurality of file data and each the file data has regular data and a variety of metadata; the high-speed storage device comprises a first data cache unit used to temporarily store regular data, and a second cache unit and a third cache unit respectively used to temporarily store first special data and second special data; and, the host is used to execute the storing operations of the storage devices. When the host reads a file data from the low-speed storage device, the regular data of the file data will be stored in the first data cache unit and the first special data and the second special data will be temporarily stored in the corresponding second cache unit and third cache unit. The first cache unit has a size larger than the sum of the second cache unit and the third cache unit.

### BRIEF DESCRIPTION OF THE DRAWINGS

FIG. 1 is a schematic drawing showing a disk cache in the prior art.

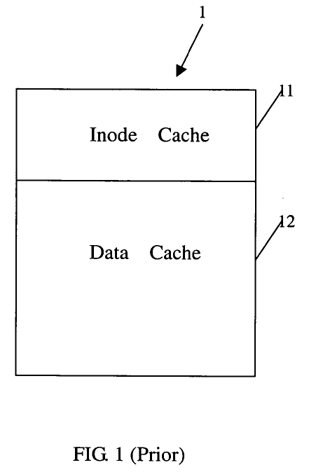

FIG. 2 is a schematic drawing showing a storage system and a file system of the present invention.

FIG. 3 is a schematic drawing showing the detailed arrangement in a disk cache according to a preferred embodiment of the invention.

FIG. 4 is a schematic drawing showing the detailed arrangement in a disk cache according to another preferred embodiment of the invention.

### DETAILED DESCRIPTION OF THE PREFERRED EMBODIMENT

The present invention partitions a disk cache in a file system into a plurality of cache units including a data cache unit used to temporarily store regular data and a plurality of dedicated cache units used to temporarily store special data, and the data cache unit and the dedicated cache units support a write-back caching function; it is for the sake of avoiding the loss of the special data owing to accessing the regular data when a storage system frequently accesses the data of the file system or accesses large files thereof, in order to increase the accessing performance of the system.

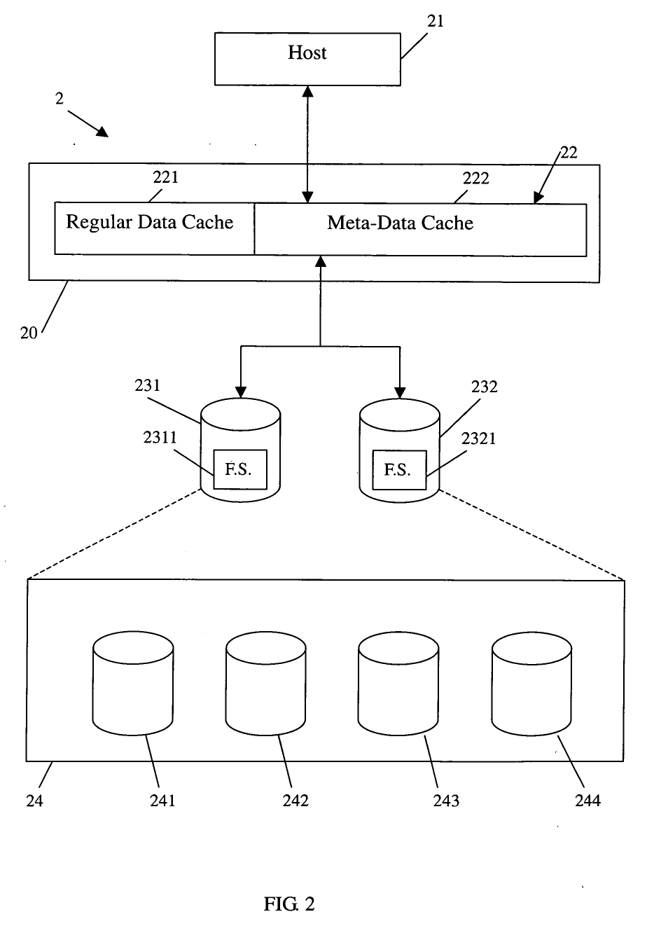

Regarding the preferred embodiment of the present invention, please refer to FIG. 2 showing the schematic drawing of a storage system 2, which comprises a host 21, a controller 20 and a disk array 24. The controller 20 further has a disk cache 22, whish is composed of a regular data cache 221 and a metadata cache 222, provided that the host 21 can access the data in the disk array 24 by way of the controller 20. The disk array 24 is possessed of a plurality of physical disk drives 241, 242, 243,244 which are grouped into two logical disks 231, 232 in this preferred embodiment. Each logical disk 231, 232 has a file system 2311, 2312. The plurality of physical disk drives 241, 242, 243,244 may be grouped into one or more logical disks, not limited in the amount of two, in another embodiments according to practical situations. Similarly, the disk array 24 may contain one or more physical disk drives, not limited in the amount of four, in another embodiments according to practical situations. Each the logical disk 231, 232 may be further partitioned into a plurality of partitioned logical disks in another embodiments, and each of which has a file system. Therefore, one logical disk may have one or more file systems.

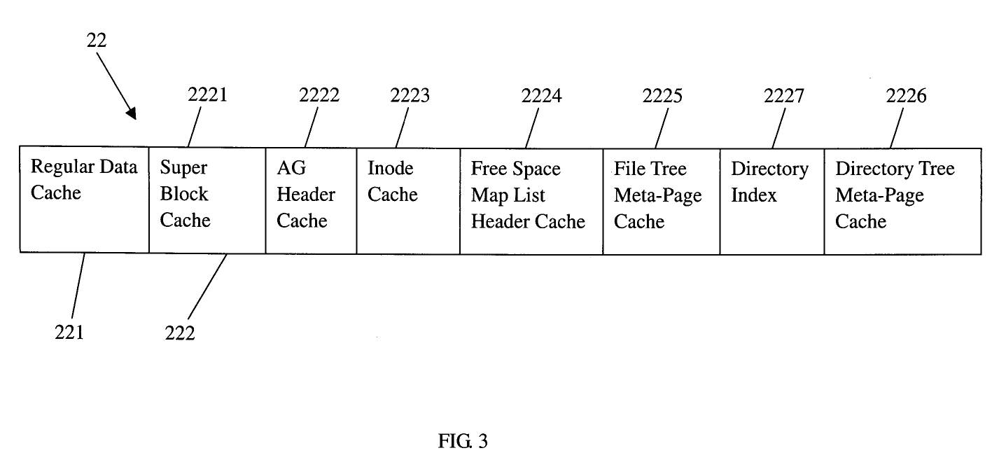

FIG. 3 shows the detailed arrangement of the disk cache 22 mentioned above. In the preferred embodiment, the disk cache 22 has, other than the regular data cache 221, seven different cache units including a super block cache 2221, an AG (allocation group) header cache 2222, an Inode (index node) cache 2223, a free space map list header cache 2224, a file tree meta-page cache 2225, a directory tree meta-page cache 2226, and a directory index cache 2227.

A file system comprises one or more regular data and a plurality of metadata. Parts of the metadata are used to describe the file system, termed “file-system metadata”, and the other parts of the metadata are used to describe file data, termed “file-data metadata”. Each of the file data is composed of the file-data metadata and the regular data so that it is possible to access both the file-system metadata and the regular data while accessing the file data.

The metadata mentioned above can be the metadata of, for example, a super block, an AG (allocation group) header, an Inode (index node), a free space map list header, a file tree meta-page, a directory tree meta-page, and a directory index. The super block and the AG header are used to describe the file system retaining them, and the rest, namely the Inode, the free space map list header, the file tree meta-page, the directory tree meta-page, and the directory index, are used to describe the file data of the file system. Of course, the names and types of metadata in different file systems may differ from each other. For example, metadata in UNIX systems further comprises a direct block, a double indirect block, and an Inode file block etc.

The super block is used to record the integral data about the logical disks 231, 232, such as the data of the size and the amount of data blocks in the logical disks 231, 232. Usually, logical disks 231, 232 can be further partitioned into a plurality of group areas in order to store files having low correlation to each other in different group areas; each group area has a corresponding AG header. Inode is used to record the properties of the file data and locations of data blocks that the file data is distributed. The free space map list header is a header used to indicate the free space map list of the free data blocks in a file system. The file tree meta-page has a plurality of block indexes to index the data blocks storing regular data.

The regular data and the metadata in the file system are stored in the logical disk corresponding to the file system. Referring to FIGS. 2 and 3, when the host 21 reads the regular data and the metadata in the file system 2311, it is executed by way of the controller 20, and the controller 20 will temporarily store the read regular data in the regular data cache 221 and temporarily store the read metadata in the corresponding dedicated metadata cache 222, for example, storing the super block in the super block cache 2221, the AG header in the AG header cache 2222, Inode in the Inode cache 2223, the free space map list header in the free space map list header cache 2224, the file tree meta-page in the file tree meta-page cache 2225, the directory tree meta-page in the directory tree meta-page cache 2226, and the directory index in the directory index cache 2227.

Therefore, when the regular data and the metadata have been stored in the corresponding cache units, the host 21 can directly find and access certain metadata, for example, the AG header from the AG header cache 2222 rather then from the disk drives with slower running speed. As the host 21 reads a large file, the regular data cache 221 in the controller 20 could be frequently updated for temporarily storing the coming regular data, but the dedicated cache unit 42 may not be renewed or just partially updated, so as to reduce the situations of losing metadata that originally exists in the dedicated cache unit 42.

If the host 21 intends to modify files in the file system, the regular data and parts of the metadata stored in the file system could be modified. Therefore, the host 21 will temporarily store the regular data and the parts of metadata being modified in the disk cache 2 in order to update the regular data cache 221 and parts of the dedicated cache 222 and then write the modified data into the disk drive by way of the disk cache 2. In this embodiment, the disk cache 2 supports a write-back caching function, which is, when the host 21 writes updated data, the data to be modified will be temporarily stored in the regular data cache 221 and the dedicated cache 222 of the disk cache 2 rather than directly written into the disk drive and then, marking the updated data as “Dirty.”. The updated data will be really written into the disk drive when the storage system 2 is available or certain duration is due. Therefore, the performance of the system will be improved.

The dedicated cache mentioned above is sorted by types. The dedicated cache could be turned into at least two types of dedicated cache units in light of different file systems and system requirements. Of course, while applying to different file systems, the names of the dedicated cache units and the objects to be temporarily stored may change, but the nature of the dedicated cache units remains, storing metadata, not the regular data.

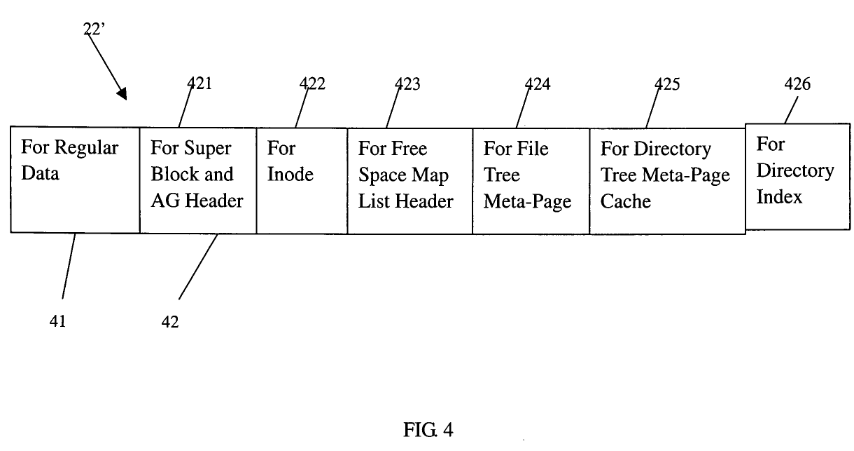

FIG. 4 is a schematic drawing showing another preferred embodiment of the present invention. Please refer to FIG. 2 simultaneously while describing FIG. 4. The disk cache 22 is divided into a regular data cache 41 and a special data cache 42. In this embodiment, the special data cache 42 is further divided into a plurality of dedicated cache units with different sizes, for example, a first dedicated cache unit 421 used to temporarily store the metadata of 512 bytes, a second dedicated cache unit 422 used to temporarily store the metadata of 1 K bytes, a third dedicated cache unit 423 used to temporarily store the metadata of 2 K bytes, a fourth dedicated cache unit 424 used to temporarily store the metadata of 4 K bytes, a fifth dedicated cache unit 425 used to temporarily store the metadata of 6 K bytes, and a sixth dedicated cache unit 426 used to temporarily store the metadata of 8 K bytes.

Therefore, when the host 21 reads the regular data and the metadata of the file system 2311, the regular data will be temporarily stored in the regular data cache 41 and the other relative metadata will be temporarily stored in the corresponding dedicated cache units according to its size. For example, the super block and the AG header will be temporarily stored in the first dedicated cache unit 421 because their sizes are 512 bytes; Inode will be temporarily stored in the second dedicated cache unit 422 because its sizes is 1 K bytes; the free space map list header will be temporarily stored in the third dedicated cache unit 423 because its sizes is 2 K bytes; the file tree meta-page will be temporarily stored in the fourth dedicated cache unit 424 because its sizes is 4 K bytes; the directory tree meta-page will be temporarily stored in the fifth dedicated cache unit 425 because its sizes is 6 K bytes; and the directory index will be temporarily stored in the sixth dedicated cache unit 426 because its sizes is 8 K bytes.

Therefore, in this preferred embodiment, when the regular data and the metadata have been temporarily stored in the corresponding cache units, in case that the host 21 intends to read certain metadata (for example, the AG header) of the file system by way of the controller 20 again, the certain metadata can be directly found and read in the dedicated data cache 42 (for example, the first dedicated cache unit 421) of the controller 20, rather than by the disk drive of slower speed. Thus, when the host 21 reads a larger file by way of the controller 20, the regular data cache 221 could be frequently renewed to temporarily store the read regular data, but the dedicated data cache 42 may not or just partially be renewed so as to reduce the situation of losing metadata that is originally existed in the dedicated data cache 42. Similarly, when the host 21 intends to modify file data, only a part of relative dedicated data cache 42 will be renewed. Consequently, the embodiment can reduce the coupling between the regular data cache 41 and the dedicated data cache 42 so that the performance of the system is improved.

Of course, in other embodiments, the sizes of the dedicated cache units 421, 422, 423, 424, 425, 426 can be configured according to the metadata of different file systems, and the quantities thereof can be changed as well according to different file systems.

Generally, the total volume of the cache units provided in a data storage system is restricted by the physical arrangement of hardware. Therefore, the increase of the deployed volume of the dedicated cache units may result in the decrease of the deployed volume of the data cache unit. However, the dedicated cache units only occupy a small part of the total volume and, oppositely, the data cache unit is in the majority (for example, the dedicated cache units have less than 5% and the data cache unit is 95% stronger), so the increase of the dedicated cache units will not influence the volume deployment of the data cache unit a lot. To be concluded, the present invention provides a plurality of dedicated cache units in the storage system for respectively storing specific metadata so that the metadata frequently used will not be lost owing to the update of the regular data, and it greatly reduces the possibilities of accessing the slow storage devices, such as hard disk drives so as to effectively improve the performance of the system.

It will be apparent to those skilled in the art that various modifications and variations can be made to the structure of the present invention. In view of the forgoing, it is intended that the present invention covers modifications and variations of this invention provided they fall within the scope of the following claims and their equivalents.

1. A cache device used in a file system, comprising:
a data cache unit used to store regular data; and
a plurality of dedicated cache units which are respectively used to temporarily store plural types of special data whereby an influence of the renewing of the data cache unit on the special data in the dedicated cache units is reduced.

2. The cache device of claim 1, wherein the plurality of dedicated cache units are of different sizes.

3. The cache device of claim 1, wherein one of the plurality of dedicated cache units is a first dedicated cache unit used to temporarily store a super block of the file system.

4. The cache device of claim 1, wherein one of the plurality of dedicated cache units is a second dedicated cache unit used to temporarily store an allocation group header of the file system.

5. The cache device of claim 1, wherein one of the plurality of dedicated cache units is a third dedicated cache unit used to temporarily store an index node (Inode) of the file system.

6. The cache device of claim 1, wherein one of the plurality of dedicated cache units is a fourth dedicated cache unit used to temporarily store a free space map list header of the file system.

7. The cache device of claim 1, wherein one of the plurality of dedicated cache units is a fifth dedicated cache unit used to temporarily store a file tree meta-page of the file system.

8. The cache device of claim 1, wherein one of the plurality of dedicated cache units is a sixth dedicated cache unit used to temporarily store a directory tree meta-page of the file system.

9. The cache device of claim 1, wherein one of the plurality of dedicated cache units is a seventh dedicated cache unit used to temporarily store a directory index of the file system.

10. The cache device of claim 1, wherein the data cache unit and the plurality of dedicated cache units support a write-back caching function.

11. A cache device used in a file system, comprising:
a first cache unit used to temporarily store regular data;
a second cache unit used to temporarily store first special data; and
a third cache unit used to temporarily store second special data, whereby an influence of the renewing of the first cache unit on the special data is reduced, wherein the first cache unit has a size larger than the sum of sizes of the second cache unit and the third cache unit.

12. The cache device of claim 11, further comprising at least one other cache unit and the cache units are of at least two different sizes.

13. The cache device of claim 11, wherein the second cache unit can temporarily store the first special data and at least one other special data of the same size with the first special data.

14. The cache device of claim 13, wherein the second cache unit is used to temporarily store a super block and an allocation group header of the file system.

15. The cache device of claim 11, wherein the third cache unit is used to temporarily store an index node (Inode) of the file system.

16. The cache device of claim 11, further comprising a fourth cache unit used to temporarily store a free space map list header of the file system.

17. The cache device of claim 11, further comprising a fifth cache unit used to temporarily store a file tree meta-page of the file system.

18. The cache device of claim 11, further comprising a sixth cache unit used to temporarily store a directory tree meta-page of the file system.

19. The cache device of claim 11, further comprising a seventh cache unit used to temporarily store a directory index of the file system.

20. The cache device of claim 12, wherein the cache units support a write-back caching function.

21. A storage system, comprising:
a plurality of storage devices, each of which has at least one file system that uses a data cache unit to temporarily store regular data, and a plurality of dedicated cache units to temporarily store plural types of special data respectively, whereby an influence of the renewing of the data cache unit on the special data is reduced.

22. The storage system of claim 21, wherein the plurality of dedicated cache units are of at least two different sizes.

23. The storage system of claim 21, wherein a first part of the plurality of dedicated cache units is of different sizes and a second part thereof is of the same sizes.

24. The storage system of claim 21, wherein the data cache unit and the plurality of dedicated cache units support a write-back caching function.

25. A storage system, comprising:
a plurality of storage devices, each of which has at least one file system that uses a first data cache unit to temporarily store regular data, a second cache unit to temporarily store first special data, and a third cache unit to temporarily store second special data whereby an influence of the renewing of the first data cache unit on the special data is reduced; wherein the first cache unit has a size larger than the sum of sizes of the second cache unit and the third cache unit.

26. The storage system of claim 25, further comprising at least one other cache unit(s) and the cache units are of at least two different sizes.

27. The storage system of claim 25, wherein the second cache unit can temporarily store the first special data and at least one other special data of the same size with the first special data.

28. The storage system of claim 27, wherein the second cache unit is used to temporarily store a super block and an allocation group header of the file system.

29. The storage system of claim 25, wherein the third cache unit is used to temporarily store an index node (Inode) of the file system.

30. The storage system of claim 25, further comprising a fourth cache unit used to temporarily store a free space map list header of the file system.

31. The storage system of claim 25, further comprising a fifth cache unit used to temporarily store a file tree meta-page of the file system.

32. The storage system of claim 25, further comprising a sixth cache unit used to temporarily store a directory tree meta-page of the file system.

33. The storage system of claim 25, further comprising a seventh cache unit used to temporarily store a directory index of the file system.

34. The storage system of claim 26, wherein the cache units support a write-back caching function.

35. A storage system, comprising:
at least one slow storage device storing a plurality of file data, wherein each of the file data comprises a plurality of regular data and plural types of metadata.
at least one fast storage device, comprising:
a data cache unit used to temporarily store the plurality of regular data; and
a plurality of dedicated cache units used to temporarily store the corresponding plural types of metadata respectively; and
a host used to execute the storing operations in the storage devices; wherein when the host reads one of the file data in the slow storage device, the regular data of the file data will be temporarily stored in the data cache unit and the plural types of metadata will be temporarily stored in the corresponding dedicated cache units.

36. The storage system of claim 35, wherein the plurality of dedicated cache units are of at lease two different sizes.

37. The storage system of claim 35, wherein a first part of the plurality of dedicated cache units is of different sizes and a second part thereof is of the same sizes.

38. The storage system of claim 35, wherein the plurality of dedicated cache units comprise a first dedicated cache unit used to temporarily store an index node (mode) of the metadata, a second dedicated cache unit used to temporarily store a free space map list header of the metadata, and a third dedicated cache unit used to temporarily store a file tree meta-page of the metadata.

39. The storage system of claim 35, wherein the plurality of dedicated cache units comprise a fourth dedicated cache unit used to temporarily store a directory tree meta-page of the metadata, and a fifth dedicated cache unit used to temporarily store a directory index of the metadata.

40. The storage system of claim 35, wherein the at least one slow storage device further stores file-system metadata, and the at least one fast storage device further comprises a corresponding dedicated cache unit used to temporarily store the file-system metadata.

41. The storage system of claim 35, wherein the plurality of dedicated cache units comprise a sixth dedicated cache unit used to temporarily store a super block of the metadata, and a seventh dedicated cache unit used to temporarily store an allocation group header of the metadata.

42. The storage system of claim 35, wherein the at least one fast storage device supports a write-back caching function, in which the host modifies one of the file data stored in the slow storage device by temporarily storing the modified data in the corresponding cache units of the fast storage device and then writing the modified data in the slow storage device by means of the cache units of the fast storage device.

43. A storage system, comprising:
at least one slow storage device possessed of at least one file system storing a plurality of file data and file-system metadata of the file system, each of the plurality of file data comprising a plurality of regular data and plural types of file-data metadata;
at least one fast storage device, comprising:
a first cache unit used to temporarily store the regular data;
a second cache unit used to temporarily store the file-data metadata; and
a third cache unit used to temporarily store the file-system metadata; and
a host used to execute storing operations of the storage devices;
wherein the host reads one of the file data stored in the slow storage device by temporarily storing the regular data in the first cache unit and others of the metadata in the corresponding second and third cache units, and the first cache unit has a size larger than a sum of sizes of the second cache unit and the third cache unit.

44. The storage system of claim 43, further comprising at least one other cache unit and the cache units are of at least two different sizes.

45. The storage system of claim 44, wherein the second cache unit is used to temporarily store an allocation group header and a super block of the file data, and the third cache unit is used to temporarily store an index node (Inode) of the file system.

46. The storage system of claim 43, further comprising a fourth cache unit used to temporarily store a free space map list header of the file system, a fifth cache unit used to temporarily store a file tree meta-page of the file system, a sixth cache unit used to temporarily store a directory tree meta-page of the file system, and a seventh cache unit used to temporarily store a directory index of the file system.

47. The storage system of claim 44, wherein the first cache unit, the second cache unit, the third cache unit, and the at least one other cache unit support a write-back caching function, in which the host modifies one of the file data stored in the slow storage device by temporarily storing the modified data in the corresponding cache units of the fast storage device and then writing the modified data in the slow storage device by means of the cache units of the fast storage device.

48. The storage system of claim 43, further comprising a fourth cache unit, a fifth cache unit, a sixth cache unit, and a seventh cache unit that the cache units are of different sizes among a part thereof and the same sizes among the other part thereof, wherein the second cache unit is used to temporarily store an index node (Inode) of the file system, the third cache unit is used to temporarily store a super block of the file system, the fourth cache unit is used to temporarily store an allocation group header of the file system, the fifth cache unit is used to temporarily store a free space map list header of the file system, the sixth cache unit is used to temporarily store a file tree meta-page of the file system, the seventh cache unit is used to temporarily store a directory tree meta-page of the file system, and the eighth cache unit is used to temporarily store a directory index of the file system, and the cache units support a write-back caching function, wherein the host modifies one of the file data stored in the slow storage device by temporarily storing the modified data in the corresponding cache units of the fast storage device, and then writing the modified data in the slow storage device by means of the cache units of the fast storage device.
